(19) United States
(12) Patent Application Publication
(10) Pub. No.: US 2002/0173994 A1
(43) Pub. Date: Nov. 21, 2002

(54) Method and apparatus for insuring an insured from identity theft peril and identity reclamation and credit restoration

(76) Inventor: Joseph M. Ferguson III, Atlanta, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 09/862,133

(22) Filed: May 21, 2001

(51) Int. Cl. G06F 17/60

(52) U.S. Cl. 705/4

(57) ABSTRACT

A method of insuring an insured for identity theft peril. The method includes submitting a claim of identity theft by an insured to an insurer. Thereafter, the method includes the step of investigating the claim of the identity theft peril to verify the identity theft peril. In response to the identity theft being verified, the method includes performing an identity reclamation and a credit restoration process. Further, in response to the identity theft being verified, identifying monetary loss by the insured. Thereafter, dispersing the insurance benefit having a value proportional to the monetary loss. The present invention includes a method for identity reclamation and credit restoration which includes the establishment of a variety of databases having form letter shells for a population of credit bureaus, a population of credit card issuers, a population of financial banking institutions, and a population of utility companies, retailers and other specialty merchants.

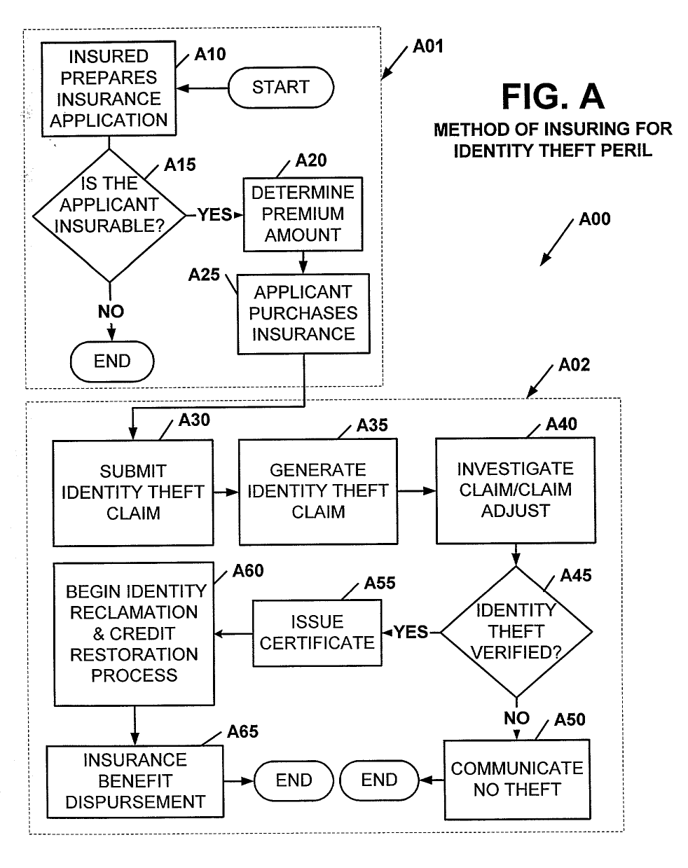

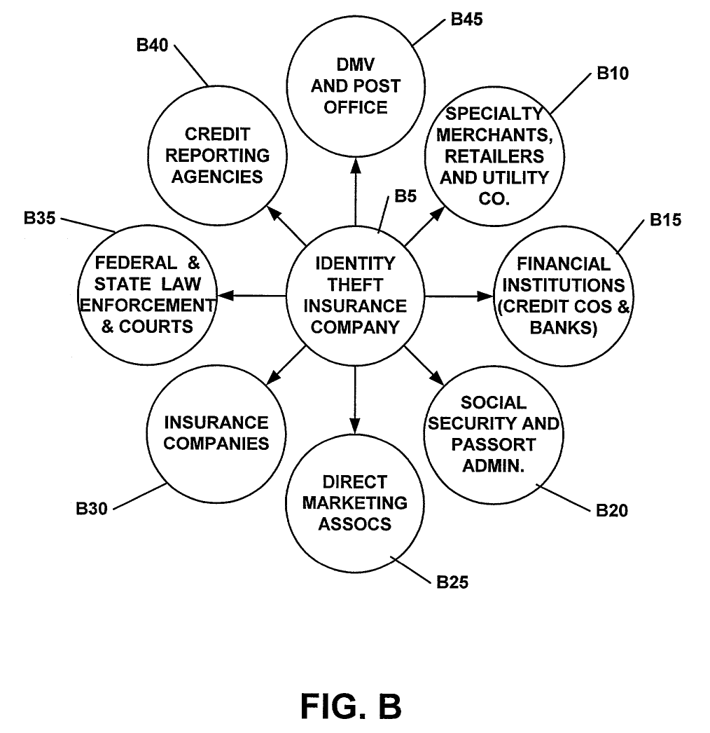

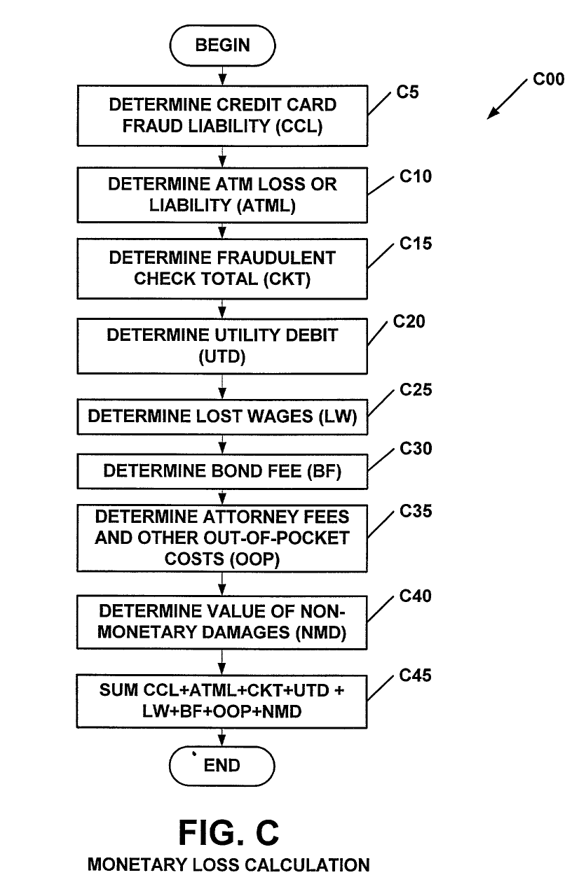

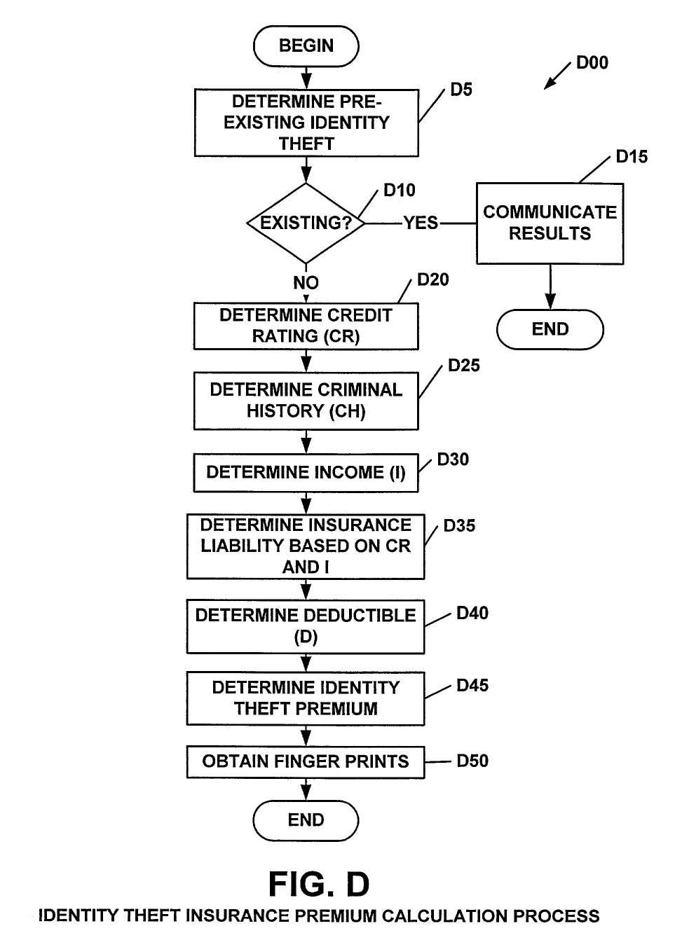

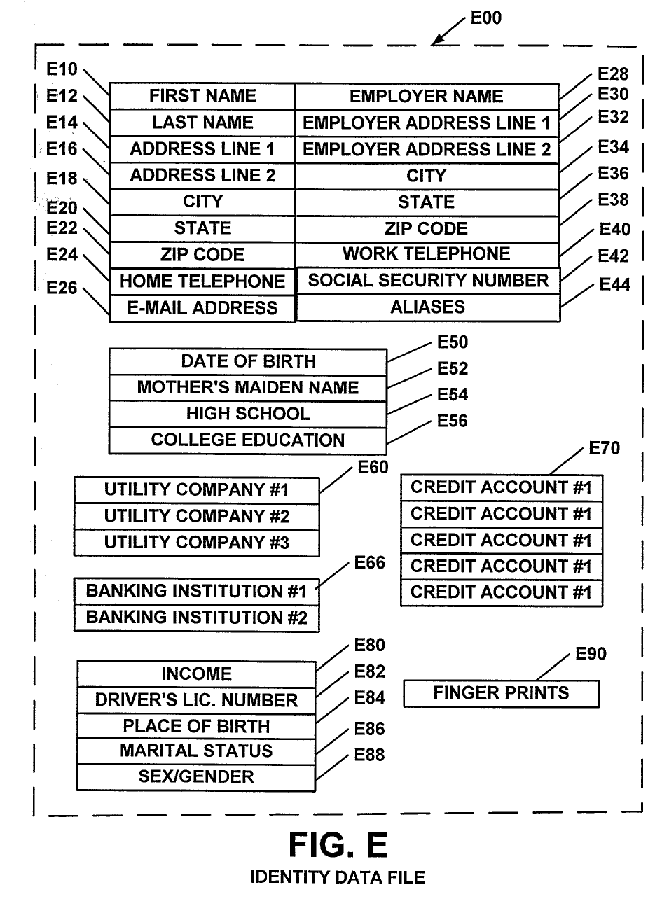

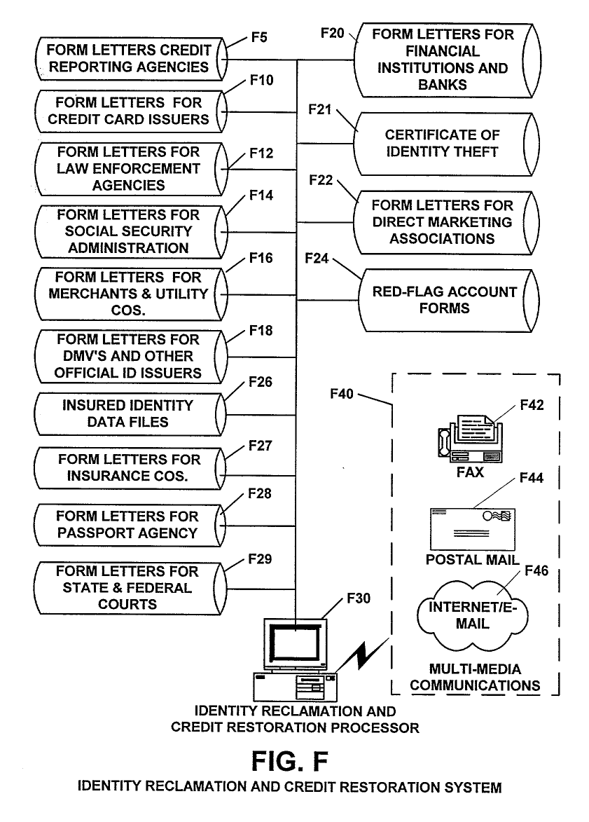

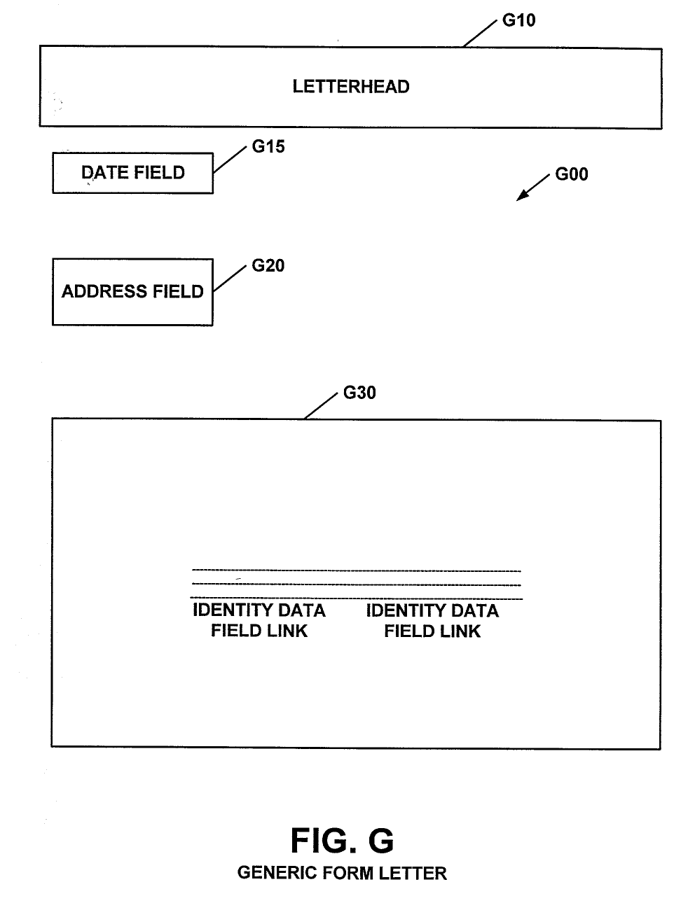

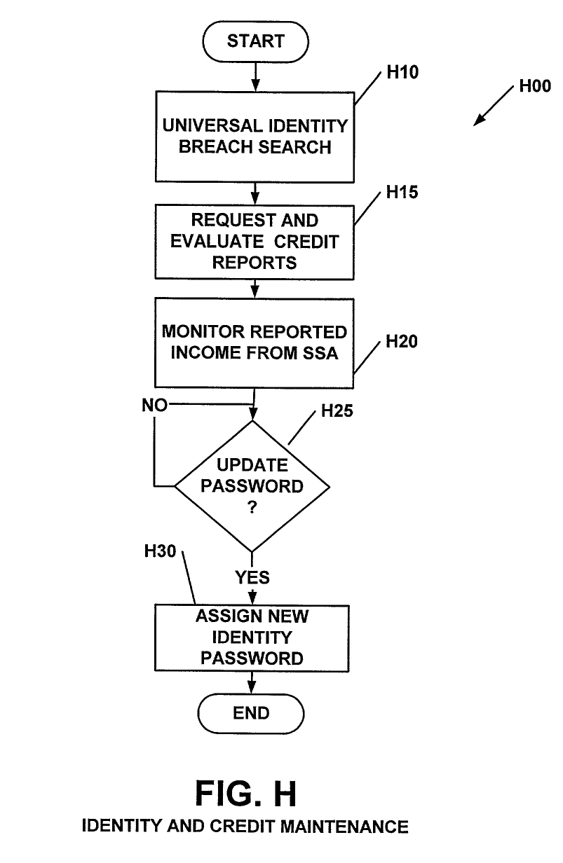

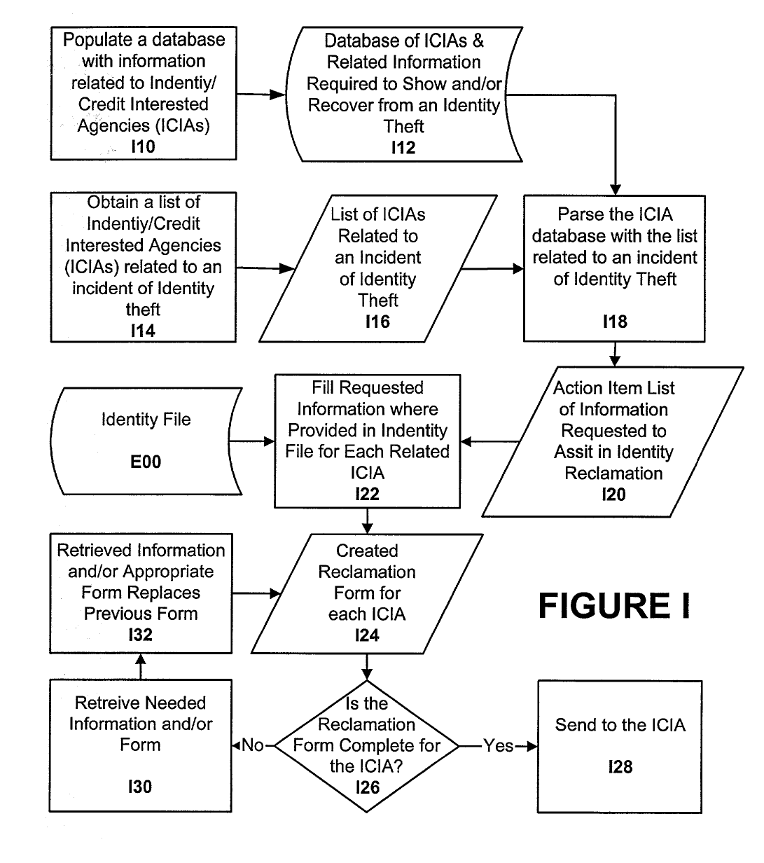

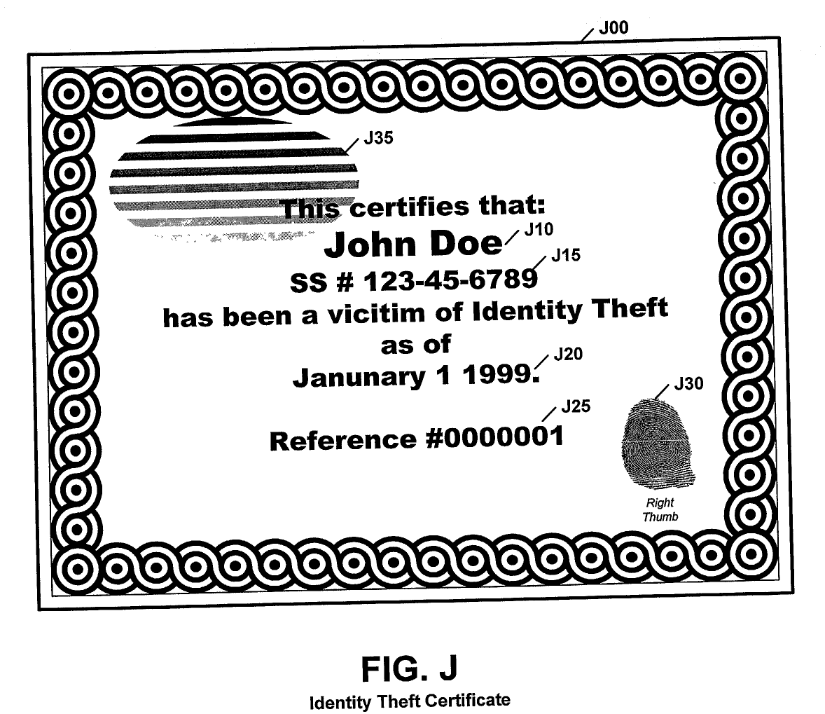

### TECHNICAL FIELD

The present invention relates to a business method and, more particularly, to a business method for insuring for identity theft peril with identity reclamation and credit restoration.

### BACKGROUND OF THE INVENTION

Some credit card companies, retailers, banks or other financial institutions have credit card insurance or credit card theft protection, plans for an annual or monthly fee. These plans, in general, offer to contact the subscriber's credit card companies in the event of a stolen purse or wallet. Some plans offer to pay the standard liability fee in the event of credit card fraud. These fees are typically $50.00. While $50.00 is not a significant amount of money, since consumers generally carry three to ten different credit cards, liability fees can quickly add-up. These protection plans only compensate for the liability fees and do not provide additional monetary compensation for legal fees or other costs that may result from identity theft.

In the past, credit card companies considered credit card fraud the cost of doing business. Therefore, the otherwise bad debt was written off except for the nominal liability fee paid by the card holder and very little attention was directed toward identity theft. Recently, Title 18 of the United States Code (USC) Section 1028, was enacted and made identity theft a federal crime punishable by fines and up to 15, 20 and 25 years in prison depending on whether the identity theft is used for drug trafficking, terrorism, etc. Title 18 USC Section 1028 also requires identity theft complaints to be filed with the major credit bureaus and appropriate law enforcement agencies. According to the Federal Trade Commission (FTC), the victim should contact the creditors of accounts, such as credit card issuers, banks and the like.

If a person has their identity stolen, their monetary loss can be as little as fifty dollars, the liability fee for a single credit card, to thousands of dollars. For example some ATM cards or checking accounts do not limit fraudulent use of the ATM card or bad checks to a mere fifty dollars. Therefore, the victim has a greater monetary liability. Moreover, a victim may experience loss due to lost wages or legal fees which may never be recuperated even after a victim has proven identity theft.

In some instances, an imposter using stolen identity may write fraudulent checks with the intent to steal money, however, imposters may want to steal your identity for other reasons. An imposter may open utility accounts (such as water and electric) to establish a false identity with which they may, apply for jobs, obtain additional false identification, such as birth certificates, passports, drivers license, register to vote, etc. For example, Departments of Motor Vehicles (DMVs), in general, accepts two months of utility bills to establish residence in a state or jurisdiction for issuance of a driver's license.

These additional false identifications may be used to obtain, Post Office boxes, cellular phone accounts, pager services, etc., in an effort to hide their true identity while involved in other major illegal activities. Therefore, identity theft is not always a result of stolen money, trashed credit and bad checks. Instead, identity theft creates aliases, from law abiding citizens, for criminals. As the result of the latter, credit is maintained or increased for periods of time or until the objects of the illegal activities are completed or the imposter apprehended for the illegal activity.

Therefore, identity theft can provide more serious legal problems requiring legal representation by an attorney. For example, an impostor may engage in numerous criminal activities such as drug trafficking, kidnapping, murder, as well as, acts of international terrorism. Therefore, a victim may suffer monetary losses from loss of employment (due to time spent in jail and/or while being interrogated), and legal fees (such as attorney fees and bonding). Further, monetary loss may be incurred as credit is denied due to erroneous credit or criminal information on the victim's records even after they have proven identity theft.

As can be appreciated, there is a continuing need for an identity theft insurance policy for an insured to cover at least in part monetary loss due to identity theft.

Further there is a continuing need for method for insuring an insured of identity theft peril and an avenue or means for reclaiming the insured's identity and compromised credit.

As will be seen more fully below, the present invention is substantially different in structure, methodology and approach from that of prior business methods.

### SUMMARY OF THE INVENTION

The preferred embodiment of the business method for identity theft insurance with identity and credit reclamation solves the aforementioned problems in a straightforward and simple manner.

Broadly, what is provided is a method of insuring an insured for identity theft peril. Additionally, the present invention provides a method and an apparatus to assist the insurer to attempt to mitigate and/or rapidly respond to the insured's losses and assist in rapidly reclaiming the use of the consumer's credit and credit related accounts.

The method includes submitting a claim of identity theft by an insured to an insurer. Thereafter, the method includes the step of investigating the claim of the identity theft peril to verify the identity theft peril. In response to the identity theft being verified, the method includes performing identity reclamation and a credit restoration process. Further, in response to the identity theft being verified, identifying monetary loss by the insured and thereafter, dispersing the insurance benefit having a value proportional to the monetary loss.

Other features of the present invention include:

1. Populating storage media with form letter shells and addresses for identity/credit interested agencies (“ICIAs”), including: a population of law enforcement agencies, a population of credit reporting bureaus, a population of credit card issuers, and a population of financial banking institutions.

2. Populating storage media with identity data representative of an identity of a person. When, an incident of identity theft of the person is determined, accessing the storage media and retrieving a respective form letter shell and address. Thereafter, the method automatically populates the respective form letter shell with the address and with at least part of the identity data to form an incident letter; and, communicates the incident letter to the address to reclaim the identity and restore the credit of the person.

3. Repeating the populating of the form letter shell for the remaining form letter shells and addresses for the population of law enforcement agencies, the population of credit reporting bureaus, the population of credit card issuers, and the population of financial banking institutions.

4. Populating storage media of the form letter shells and addresses for check guarantee companies. These companies include such companies similar to CheckRite and Telecheck.

5. Populating storage media with form letter shells and addresses for a population of judicial entities, including Federal and State courts, including without limitation criminal court and administrative bodies.

6. Populating storage media with form letter shells and addresses for a population of divisions of motor vehicles or other government personal identification issuers. These entities include, without limitation, the Secret Service, Social Security Administration, United States Postal Service, State and Federal taxing agencies, passport and naturalization agencies, professional licensing organizations including those for medical and legal related professions. Following this population, a repeating of the populating of the form letter shells and addresses for the population of the divisions of motor vehicles or the other government personal identification issuers may be performed. The form letter shell may also be populated with notification to each division of motor vehicles to cease selling of information related to the stolen identity.

7. Populating storage media with form letter shells and addresses for a population of companies, including without limitation: specialty merchants, utility companies, phone companies, Internet Service Provider companies, cellular phone companies, insurance companies, other service providers, and retailers; and, repeating the populating of the form letter shells and addresses for the population of specialty merchants, the population of utility companies and the population of retailers.

8. Populating storage media with form letter shells and addresses for a population of direct marketing associations; and, repeating the populating of the form letter shells and addresses for the population of direct marketing associations. The form letter shells may be populated with notification to each direct marketing association to cease and desist in the marketing of the stolen identity.

9. Populating storage media with form letter shells to establish a red-flag account with the population of credit bureaus and credit card issuers; and, repeating the populating of the form letter shells for the red-flag account.

10. Populating a data base with required information for an ICIA to assist in combating an identity theft.

11. Obtaining a list of ICIAs related to an identity theft incident.

12. Providing a list of needed information and forms needed related to an incident of identity theft.

An advantage of the present invention is to provide the victim of identity theft peril legal assistance to eliminate if not prevent wrongful imprisonment as the result of identity theft peril.

Another advantage of the present invention is to provide the victim of identity theft peril with financial compensation through insurance benefits to compensate for monetary loss and other out-of-pocket expenses.

The above and other objects and features of the present invention will become apparent from the drawings, the description given herein, and the appended claims.

### BRIEF DESCRIPTION OF THE DRAWINGS

For further understanding of the nature and objects of the present invention, reference should be had to the following detailed description, taken in conjunction with the accompanying drawings, in which like elements are given the same or analogous reference numbers and wherein:

FIG. A illustrates a flowchart of the business method for insuring for identity theft peril of the present invention;

FIG. B illustrates a block diagram for notifying agencies of an identity theft incident of the present invention;

FIG. C illustrates a flowchart for the monetary loss calculation of the present invention;

FIG. D illustrates a flowchart of the identity theft insurance premium calculation process of the present invention;

FIG. E illustrates an exemplary identity data file for each of the insured;

FIG. F illustrates a general block diagram of the identity reclamation and credit restoration system of the present invention;

FIG. G illustrates a generic form letter shell of the present invention; and,

FIG. H illustrates a flowchart for the identity and credit maintenance process of the present invention.

FIG. I illustrates a flowchart for a method of providing a list of information needed for assisting in recovering from an identity theft incident.

FIG. J illustrates a Certificate of Identity Theft form to be used by the insured to demonstrate that they have been a victim of Identity Theft.

### DESCRIPTION OF EXEMPLARY EMBODIMENTS

Referring now to FIG. A, the business method for insuring an insured for identity theft peril (hereinafter referred to as “the method”) is generally referenced by the numeral A00. In general, the insurance product will insure the insured for monetary losses incurred in the event of identity theft peril. The product general entails two main components, Obtaining the Insurance A01 and Processing a claim A02.

The method A00 begins at with Obtaining the Insurance A01 with Step A10 where the applicant prepares an Insurance Application, or alternatively one is prepared on the applicant's behalf. This is followed by a decision step, Step A15 which determines if the applicant is insurable. If the applicant is not insurable the process end. However, if the applicant is insurable, then Step A20 determines the amount of the premium to be charge to the applicant. One skilled in the art will appreciate that the present invention provides the basis of determining the amount of the premium. Factors affecting the amount include the amount of coverage sought, the amount of deductible, the risk of identity theft for that individual, and the probability of restoration and recovery. These and other factors are discussed in greater detail later in the present application. Once the premium amount is premium price is determined, then the applicant purchases the insurance, thereby becoming the “insured.”

Obtaining the Insurance A01 ends and Process a claim A02 is able to occur. Process a claim A02 may never occur or may occur multiple times in relation to Obtaining the Insurance A01.

The first step of Processing a claim A02 is Step A30 where the insured will submit an identity theft claim to the identity theft insurance company B5. Step A30 is followed by Step A35 where an identity theft claim is generated. Step A35 is followed by Step A40 where the claim is investigated by an investigator or claim adjuster of the identity theft insurance company B5. Step A40 is followed by a decision step, Step A45. If the determination is NO at Step A45, the insured is notified that there is no identity theft at Step A50.

On the other hand, if the determination is YES at Step A45, the investigator or claim adjuster of the identity theft insurance company B5 issues, as shown in FIG. J a Certificate of Identity Theft J00 in Step A55. One skilled in the art will appreciate that once the present invention is known by other to produce a certificate which has a reasonable probability of validity in relation to correctly notifying interested parties that an individuals theft has occurred, Certificate of Identity Theft J00 will provide proof of theft to multiple parties and organizations.

Certificate J00 preferably includes Insured's Name J10, Identification Number J15 such as the insured Social Security Number, approximate Date of Theft J20, Reference Number J25 to allow for easy confirmation of the theft, as well as Identification Proof J30 such as a thumb or finger print. Identifying Information J15 may also be the insured's social security number, or other identifying information including date of birth, current address, phone number, draft registration number, address, and the like. Proof of Authentication J35 shows this certificate to be a true document from the Insurer may be a hologram, a watermark or the like. Finally, one skilled in the art will appreciate that digital certificates may be utilized as Certificate J00. Identification Proof J30 may utilize any physical characteristic for which is capable of or tends to establish identity. For example, use of finger prints, eye imaging, DNA/RNA chains, voice recognition and the like.

Following Issuing a Certificate of Identity Theft in Step A55 the identity reclamation and the credit restoration process continues at Step A60. It should be noted that the acts for the identity restoration and the acts for the credit restoration process overlap and are combined together. Additionally it should be noted that Step A55 and Step A60 can be combined or reversed in whole or in part. Step A60 is followed by Step A65 where the insurance benefit is dispersed. The insurance benefit is a function of the monetary loss of the insured as determined by the monetary loss calculation process C00 (FIG. C).

Referring now to FIG. D, the flowchart for the identity theft insurance premium calculation process D00 is shown. As can be appreciated, the identity theft insurance premium calculation process D00 is performed to establish a relationship between the insured and the identity theft insurance company B5. The identity theft insurance premium calculation process D00 begins with Step D5 where a process for determining pre-existing identity theft is present. When determining whether pre-existing identity theft is present the prospect is provided with reports from the credit bureaus to determine abnormalities. The credit bureau reports can be used to verify at least in part credit account balances. A reported earning report from the Social Security Administration may also generated for verification. A search for existence of imposters in other states such as through criminal records can be performed.

Step D5 is followed by Step D10 where a determination is made whether pre-existing identity theft exists. If the determination at Step D10 is YES, the results are communicated to the prospect at Step D15. On the other hand, if pre-existing identity theft is does not exist, Step D10 is followed by Step D20. At Step D20 the prospect's credit rating (CR) is determined. Factors to consider and review include such things as criminal record and the like. One skilled in the art will appreciate the number of different aspects one to review for creation of said rating. Step D20 is followed by Step D25 to review and determine, if any, the applications criminal records. Step D25 is followed by Step D30 to determine the income (I) of the prospect. As can be appreciated, the higher the CR and/or higher the I creates a higher liability for total monetary loss in the event of identity theft peril. Step D30 is followed by Step D35 where a determination is made regarding the liability based on the CR and the I in an underwriting process for identity theft peril.

Step D35 is followed by Step D40 where the deductible is determined.

It should be noted that the deductible may be determined before Step D35. Step D40 is followed by Step D45 where the identity theft premium is calculated to establish the relationship between the insured and the identity theft insurance company B5. Step D45 is followed by Step D50 where applicants finger prints are taken and stored. This will assist in determining and later proving the true identity of the applicant. As mentioned prior, this step can be augmented or replaced by recording other proof of identity which can later be used as Identification Proof J30.

Referring now to FIG. C, the flowchart for the monetary loss calculation process C00 is shown. The monetary loss calculation process C00 begins with Step C5 where a total of the credit card fraud liability fee (CCL) is calculated. For example, if only one credit card was tampered with by the imposter, the CCL would be approximately $50.00. However, if the imposter used other cards or was issued other credit cards, the CCL for the other credit cards is added together. However, if the liability or loss incurred is less than the CCL of the card, the liability or loss would be added to the total. Step C5 is followed by Step C10 where a determination of the ATM loss or liability (ATML) is determined. Since each banking or financial institution B15 is different, the ATML varies from one insured to the other. The ATML may include a liability fee or may include the total loss to the insured. ATML will also include risk of loss in relation to the use of the card or other related bank cards as debit cards. Step C10 is followed by Step C15 where a total of fraudulent checks (CKT) is calculated. Step C15 is followed by Step C20 where the utility debit (UTB) is calculated such as for cellular telephone use. Utility debit may occur as the result of an imposter engaging in criminal activity. For example, once the criminal activity is complete by an imposter or if the imposter is apprehended, the utility debt may become delinquent and/or additional or first time deposits maybe required. This is also the case for fraudulent use of credit cards.

Step C20 is followed by Step C25 where lost wages (LW) by the insured is calculated such as the result of improper imprisonment, interrogation and court appearances. Step C25 is followed by Step C30 where bond fees BF are determined. Step C30 is followed by Step C35 where attorney fees are calculated and other out-of-pocket expenses (OOP). The out-of-pocket expenses may further include check canceling fees and check ordering fees for new account activation. OOP includes monetary damages not easily categorized above. Step C35 is followed by Step C40 which calculates Non-Monetary Damages (NMD). These damages can include emotional distress and the like.

Step C40 is followed by Step C45 the total of the monetary loss is calculated by adding or summing the CCL, the ATML, the CKT, the UTB, the LW, the BF, the NMD, and the OOP, including the attorney fees, together.

Furthermore, the total of the monetary loss calculated in Step C45 may be subtracted from the policies deductible D to determine the insurance benefit disbursement of Step A45.

Additionally, the present invention will allow for a distribution of material to assist the insured, or prospective insured, to minimize and/or decrease the risk of identity theft. Preferably a packet of material is provided to the insured or prospective insured containing instructions for the insured to take to reduce the risk. One skilled in the art will appreciate the potential contents of such a packet as well as the fact that the risk will be reduced to the Insurer of such a person. Therefore, a rate reduction maybe available to those who follow instruction from such a packet.

Referring now to FIGS. B, E and F, the identity reclamation and credit restoration system will be described in detail. As shown in FIG. B, the identity theft insurance company B5 communicates with the specialty merchants and utility companies B10 to identity the unauthorized car purchases and utility debit (UTB) if any. The identity theft insurance company B5 communicates with the social security and passport administrations B20, the insurance companies B30, the state and federal courts and law enforcement agencies B35, the credit reporting agencies B40 and the financial institution including all banks and credit companies, including without limitation credit card companies B15. Furthermore, the identity theft insurance company B5 communicates with the DMVs and the Post Office B45, and direct marketing associations B25. One skilled in the art may appreciate that direct marketing associations B25 receiving incorrect address changes may be a benefit, potentially the only benefit, to the insured suffering identity theft, and updates may be undesired.

Referring now to FIG. F, a general block diagram of the database system for the identity reclamation and credit restoration process is illustrated. The insurance company B5 stores form letter shells in a plurality of databases F5, F10, F12, F14, F16, F18, F20, F22 and F24. For letter shells for credit reporting agencies are stored database F5. Database F10 includes the form letter shells for all of the credit card issuers such as VISA, MASTER CARD, AMERICAN EXPRESS, etc. The form letters content include reporting of the identity theft, canceling of any existing accounts, and forms for establishing new accounts in the insured's name. This provides for (1) stopping identity theft; (2) reclaiming the insured's identity and (3) restoring the insured's credit. Furthermore, when establishing a new account, the form letter includes links all of the insured identity information and contact information stored in the insured identity data files database F26. The identity data file is described later in detail with regard to FIG. E. Additionally, an identity password may be assigned by the insurance company B5 and communicated with each of certified notifications via the form letters. The database F10 includes the address for each credit card issuer and is directed to the Fraud Departments thereof.

Database F12 includes the form letters for law enforcement agencies including local police for all states and jurisdictions including the addresses. The law enforcement letters database F14 may further include submission of information for filing a police report or complaint of the identity theft in compliance with Title 18 USC—Section 1028. Database F14 includes form letters for the Social Security Administration to request reported earnings. The database F16 includes form letters specialty merchants and utility companies. Specialty merchants may include automobile dealerships, retail merchants, etc. The database F16 includes the addresses for each of the specialty merchants and utility companies.

The database F18 includes forms for DMVs and other government personal identification (ID) issuers to cease selling of the identity. In some states, a driver's license may include a social security number. For example, a social security number may be provide under a social security number heading or may be the driver's license number. Recently, some states provide allows the ID or driver's license applicant to use a different number other than the social security number. Therefore, for those states which use the social security number for the driver's license number, a new number is generated for the insured and submitted accordingly.

The database F20 includes the form letters for financial institutions and banks including bank clearinghouses. Database F22 is form letters to direct marketing associations to cease and desist in the marketing of the stolen identity. Database F24 includes the forms for the creation of a red-flag account.

Referring now to FIG. E, the identity data file E00 is shown and is stored in the insured identity data files of database F26 for each of the insured. The identity data file E00 includes personal identity information data fields such as the first name E10, the last name E12, the address on address lines E14 and E16, city E18, state E20, zip code E22, home telephone E24 and e-mail address E26.

Employment information data fields includes data fields for employer name E28, employer address lines 1 and 2 E30 and E32, city E34, state E36, zip code E38, work telephone E40, Social Security Number E42 and aliases E44 such as for a maiden name. It should be noted, that the employment information may include data field (NOT SHOWN) for employment history for the past 5, 7 or 10 years.

Other personal information data fields includes fields for entering date of birth E50, mother's maiden name E52, high school E54 and college education E56. In the preferred embodiment, other personal information include data fields for income E80, driver's license number E82, place of birth E84, marital status E86 and sex or gender E88.

The identity data file E00 also provides for data fields E60 for identifying utility company accounts; data fields E66 for identifying banking institutions; and data fields E70 for credit account numbers and creditors.

The identity data file E00 also provides for data fields E90 for entry of Finger Print data. One skilled in the art will appreciate that other forms of physical proof may include blood samples, DNA/RNA chains, eye related images and the like.

The data fields may be populated via an online session through the Internet. However, the information may be provided via a questionnaire.

Referring now to FIG. G, a generic form letter shell G00 is shown. The identity theft may result from different losses therefore different form letter formats will be used. For example, identity theft may be an attempt to steal money. Therefore, the identity recovery may be as simple as the cancellation of bank accounts, check cancellations, credit card cancellation and the payment of the liability fee of $50.00 for each credit card fraudulently used.. Therefore, the identity reclamation and credit restoration is primarily focused on the credit restoration. On the other hand, if the identity theft created an alias for use in illegal activities, the identity reclamation and credit restoration process would primarily focus on identity reclamation to minimize future monetary loss and eliminate a criminal record. Nevertheless, in some instances both types of identity theft converge, especially if the imposter using the alias completes their objectives.

In general, the generic form letter shell G00 includes a letterhead field G10, date data field G15, address data field G20 and a letter data field G30 including links to identity data fields stored in database F26.

Returning again to FIG. F, it should be noted that all communications may be performed via multi-media communications F40. Any mailed communications through the United States Postal Service F44 are certified. In an alternate embodiment, if the communications are sent via the Internet F46 in the form of an e-mail communications via the identity reclamation and credit restoration processor F30. An e-mail communication is first assembled using a standardized electronic-mail transfer protocol which may be sent with a digital signature. Digital signatures are well known for use in encryption and secure communications. Therefore, no further discussion regarding digital signatures are necessary.

The e-mail communication includes an e-mail address header which is automatically populated and a text section for insertion of the generic form letter G00 or other alert. Alternately, the identity reclamation and credit restoration processor F30 may be equipped with a printer to print the hard copy form letters. Additionally, the identity reclamation and credit restoration processor F30 may include a fax modem for fax communications F42 of the form letters via a fax transmission protocol.

The identity reclamation and credit restoration processor F30 accesses the stored form letter shells in a plurality of databases F5, F10, F12, F14, F16, F18, F20, F21, F22, F24, F26, F27, F28 and F29 and automatically populates the data fields of the generic form letter G00, accordingly. Further, the identity reclamation and credit restoration processor F30 accesses the identity data file in database F26 and automatically populates the generic form letter G00 with the linked data.

Referring now to FIG. H, the flowchart for the identity and credit maintenance process is shown. The identity and credit maintenance process H00 begins with Step H10 where a universal search for identity breaches are conducted. For example, an imposter may only write fraudulent checks in the name of the insured. On the other hand, an imposter may have changed addresses on existing credit card accounts or have new credit card accounts opened. Step H10 is followed by Step H15 where a credit report is requested and evaluated for maintenance. Therefore, abnormal patterns of credit requests and unauthorized accounts can be rapidly determined. Step H15 is followed by Step H20, where monitoring of reported income or earnings from the Social Security Administration is performed. Additionally, Internet scans for identity information may be performed during Step H10.

Step H20 is followed by Step H25 where a determination is made regarding the need to update the identity password. Therefore, maintenance of the identity and credit may include periodic issuance of a new identity password issued by the insurance company B5 or other agency at Step H30.

Referring now to FIG. I, the flowchart depicting a method of obtaining the information and forms necessary to assist in combating an incident of identity theft. Step I10 populates ICIA database I12 with information related to Identity/Credit Interested Agencies (ICIAs). As discussed previously these agencies include law enforcement agencies, credit reporting bureaus, credit card issuers, financial banking institutions, and the like. It will be readily apparent to one skilled in the art of what additional companies, groups, agencies, and individuals will be incorporated as ICIAs. Database I12 can include information required, needed or desired by each ICIA in combating an identity theft incident. This information can include the form of proof required to contest a charge (financial and/or criminal). For example, a notarized statement might be required by a particular ICIA. Other may required an affidavit. For example, in relation to a law enforcement agency, information and forms necessary regarding reporting of the theft incident can be included as well as information and forms necessarily to prove that a criminal charge was brought on the wrong person for various charges and/or activities.

Additionally, an “identity theft incident” should not be construed to be limited to a single occurrence. It is not uncommon for a stolen identity to be used by more than one person. Therefore the term “incident” as used herein, should be viewed broadly and to encompass more than a single discrete occurrence of identity theft. Rather the term “incident” can encompass a multitude of discrete occurrences of identity theft over a substantial period of time.

When such an incident recognized then, a list of ICIAs related to the incident can be obtained and/or generated, as shown in STEP I14. This recognition can be accomplished in a multitude of ways. For example, the individual or representative thereof, can submit such a claim. Or a flag could be generated via a credit and/or account activity watch. This flag could be triggered by a multitude of appropriate occurrences or combinations thereof. For example, abnormal credit activity, substantially large purchases, out of locale credit activity (i.e. utility activation outside of living area), or the like can be used to “flag” an account. The flagging agency could either then immediately act or could follow-up with the individual to ascertain the correctness of the “flag.”

STEP I14 will then produce a List of ICIAs Related to an Incident of Identity Theft 116. This list need not be all inclusive, but can be limited through user and/or computer selection. For example, this list can be limited to credit agencies and financial institutions.

STEP I18 will then parse Database I12 with List I16 to obtain an Action Item List of Information to Assist in Identity Reclamation I20. List I20 can then be utilized to attempt to recover from the identity theft.

As shown in FIG. E, identity data file E00 then can be used to fulfill some, if not all the requirements, in List I20 by Step I22, thereby creating a reclamation form for each ICIA I24. Each said form should be evaluated for completeness and/or proper form I26. If the form is complete and in the correct format, the it can be sent to the ICIA as shown in Step I28. However, if form I24 is not in the correct format and/or not complete, then the needed information must be collected and/or the proper form must be gathered as shown in Step I30. The correct information and/or proper form should be completed as shown in Step I32. The form can be re-evaluated at Step I24 to ensure proper form and completeness. If complete, as evaluated in Step I26, then it is sent to the ICIA as shown in Step I28. If not complete and in the proper form under the evaluation in Step I26, Step I30 is performed again. Step I28 can be carried out as discussed in relation to Step F40 as shown in FIG. F.

Step I24 of FIG. I can provide a “head start” to reclamation of the identity, as typically time is of the essence in these situations and the present invention provides a substantial benefit in such reclamation attempts

The preceding embodiment is given by way of example only, and not by way of limitation to the invention. The true essence and spirit of this invention are defined in the appended claims, and is not intended that the embodiment of the invention preceding should limit the scope thereof. It will be appreciated that the present invention can take many forms and embodiments. Variations and combinations thereof obvious to one skilled in the art will be included within the invention defined by the claims.

What is claimed is:

1. A method of insuring an insured for identity theft peril comprising the steps of:
(a) submitting a claim of identity theft by an insured to an insurer;
(b) investigate the claim of the identity theft to verify the identity theft;
(c) in response to the identity theft being verified, performing an identity reclamation and credit restoration process; and
(d) in response to the identity theft being verified, identifying monetary loss by the insured; and,
(e) dispersing the insurance benefit having a value proportional to the monetary loss.

2. The method of claim 1, wherein the step (c) includes the steps of:
(c1) communicating a certified notification of the identity theft to law enforcement agencies and court systems.

3. The method of claim 1, wherein the step (c) includes the steps of:
(c1) communicating a certified notification including submission of information for filing a police report of the identity theft for all identity theft modalities.

4. The method of claim 1, wherein the step (c) includes the steps of:
(c1) communicating a certified notification to the Social Security Administration.

5. The method of claim 1, wherein the step (c) includes the steps of:
(c1) communicating a certified notification to specialty merchants;

6. The method of claim 1, wherein the step (c) includes the steps of:
(c1) communicating a certified notification to credit reporting bureaus;

7. The method of claim 1, wherein the step (c) includes the steps of:
(c1) communicating a certified notification to credit card issuers

8. The method of claim 1, wherein the step (c) includes the steps of:
(c1) communicating a certified notification to division of motor vehicles or other government personal identification issuers

9. The method of claim 8, wherein the certified notification includes notification to cease selling of the identity.

10. The method of claim 1, wherein the step (c) includes the steps of:
(c1) communicating a certified notification to direct marketing associations to cease and desist in the marketing of the stolen identity.

11. The method of claim 1, wherein the step (d) includes the steps of:
(d1) identifying a total of credit card liability (CCL);
(d2) identifying a ATM loss or liability (ATML);
(d3) identifying a fraudulent check total (CKT); and
(d4) identifying a non-monetary damage amount (NMD).

12. The method of claim 1, wherein the step (d) includes the steps of:
(d1) calculating a value representative of a lost wages; and
(d2) calculating a value representative of out-of-pocket expenses.

13. The method of claim 12, wherein the out-of-pocket expenses includes check canceling fees; check ordering fee for new account activation.

14. The method of claim 13, wherein the out-of-pocket expenses includes attorney's fees.

15. The method of claim 14, wherein the out-of-pocket expenses includes a bond fee.

16. The method of claim 1, further includes prior to step (a) the steps of:
(f) determining a crediting rating for a prospect;
(g) determining an income for the prospect;
(h) determining a deductible;
(i) evaluate the risk associated with the prospect based on the credit rating and the income; and,
(j) calculating a premium for insuring the prospect as the insured.

17. The method of claim 16, further comprising prior to step (h) the steps of:
(k) evaluating the prospect for pre-existing identity theft.

18. The method of claim 1, further comprising the steps of:
(f) performing a identity maintenance procedure to maintain the reclaimed identity of the insured.

19. The method of claim 1, wherein the step (f) includes the steps of:
(f1) requesting of credit reports from credit reporting bureaus;
(f2) evaluating of the credit reports including abnormal patterns of credit requests and established accounts; and,
(f3) communication of the credit reports to the insured and results of the evaluation.

20. The method of claim 1, wherein the step (c) includes the steps of:
(c1) establishing a red-flag account.

21. The method of claim 1, wherein the step (c) includes the steps of:
(c1) establishing a red-flag account including communicating certified red-flag forms to credit issuers.

22. A method of identity reclamation and credit restoration comprising the steps of:
(a) populating storage media with form letter shells and addresses for a population of law enforcement agencies, a population of credit reporting bureaus, a population of credit card issuers, and a population of financial banking institutions;
(b) populating storage media with identity data representative of an identity of a person;
(c) determining an incident of identity theft of said person;
(d) in response to step (c), accessing the storage media and retrieving a respective form letter shell and address;
(e) automatically populating the respective form letter shell with the address and with at least part of the identity data to form an incident letter; and,
(f) communicating the incident letter to the address to reclaim the identity and restore the credit of the person.

23. The method of claim 22, further comprising the step of:
(g) repeating steps (d), (e) and (f) for the remaining form letter shells and addresses for the population of law enforcement agencies, the population of credit reporting bureaus, the population of credit card issuers, and the population of financial banking institutions.

24. The method of claim 23, wherein the communicating includes certified mailing via the U.S. Postal Service.

25. The method of claim 23, wherein the communicating includes e-mailing or faxing.

26. The method of claim 23, wherein:
the step (a) further includes the step of:
(a1) populating storage media with form letter shells and addresses for a population of divisions of motor vehicles or other government personal identification issuers; and,
further comprising the step of:
(g) repeating steps (d), (e) and (f) for the form letter shells and addresses for the population of the divisions of motor vehicles or the other government personal identification issuers.

27. The method of claim 26, wherein the form letter shell is populated with notification to each division of motor vehicles to cease selling of information related to the stolen identity.

28. The method of claim 23, wherein:
the step (a) further includes the step of:
(a1) populating storage media with form letter shells and addresses for a population of specialty merchants, a population of utility companies and a population of retailers; and,
further comprising the step of:
(g) repeating steps (d), (e) and (f) for the form letter shells and addresses for the population of specialty merchants, the population of utility companies and the population of retailers.

29. The method of claim 23, wherein:
the step (a) further includes the step of:
(a1) populating storage media with form letter shells and addresses for a population of direct marketing associations; and,
further comprising the step of:
(g) repeating steps (d), (e) and (f) for the form letter shells and addresses for the population of direct marketing associations.

30. The method of claim 29, wherein form letter shell is populated with notification to each direct marketing associations to cease and desist in the marketing of the stolen identity.

31. The method of claim 23, wherein:
the step (a) further includes the step of:
(a1) populating storage media with form letter shells to establish a red-flag account with the population of credit bureaus and credit card issuers; and,
further comprising the step of:
(g) repeating steps (d), (e) and (f) for the form letter shells for the red-flag account.

32. The method of claim 22, further comprising the steps of:
(g) request reported earnings from the Social Security Administration.

33. The method of CLAIM I, wherein the step (d) includes the steps of:
identity established credit card accounts by imposter;
canceling the established credit card accounts.

34. A method of identity reclamation and credit restoration through an Identity/Credit Interested Agency (“ICIA”) database for comprising the steps of:
(a) populating an ICIA database with the required information for a plurality of ICIAs.

35. The method of claim 34, wherein the said required information comprises the type and form of information required by the ICIA to assist in identity reclamation and credit restoration.

36. The method of claim 35, further comprising the steps of:
(b) obtaining a list of ICIAs related to an incident of identity theft;
(c) parsing the ICIA database with the list of creditors; and
(d) obtaining a list of needed information from said parsing.

37. The method of claim 36, further comprising the steps of:
(e) obtaining an identity file for an individual relating to their identity;
(f) filling in needed information from said identity file; and
(g) preparing forms for each said ICIA in said list of ICIA related to an incident of identity theft.

38. The method of claim 37, further comprising the steps of:
(h) transmitting the ICIA form, if complete and in proper form, to said ICIA; or
(i) requesting needed information or proper form if not complete.

39. An apparatus for identity reclamation and credit restoration comprising:
a creditor database having the type and form of information required by an Identity/Credit Interested Agency (“ICIA”) to assist in identity reclamation and credit restoration;
a computer system having;
an obtaining software code capable of obtaining a list of creditors related to an identity theft incident,
an ICIA parsing software code capable of parsing said creditor database with said list of creditors and obtaining an action item list having the type and form of required information for said identity theft incident, and
a providing software code for providing said action item list.

40 The apparatus of claim 39 wherein said apparatus further has;
an identity file providing data regarding the individuals identity; and
wherein said computer system further has a form incorporation code capable of incorporating data from said identity file where requested and/or needed by said action item list.

41. The apparatus of claim 40 wherein said apparatus further has;
an automated transmission capabilities, wherein said transmission capabilities comprises mail, facsimile, electronic transmission, and video capabilities.

42. A computer readable medium capable of performing the steps of:
(a) populating an Identity/Credit Interested Agency (“ICIA”) database having the type and form of information required by the ICIA to assist in identity reclamation and credit restoration;
(b) obtaining a list of ICIAs related to an identity theft incident;
(c) parsing said ICIA with said list of ICIAs and obtaining an action item list having the type and form of required information for said identity theft incident.

43. The medium of claim 42 further capable of performing the step of:
(d) providing said action item list.
